(19) United States
(12) Patent Application Publication
(10) Pub. No.: US 2016/0305569 A1
(43) Pub. Date: Oct. 20, 2016

(54) SOLENOID VALVE

(71) Applicant: ROBERT BOSCH GMBH, Stuttgart (DE)

(72) Inventors: Joerg Schmid, Achern (DE); Katharina Droll, Buehl (DE); Georg Reeb, Buehl Eisental (DE)

(21) Appl. No.: 15/102,024

(22) PCT Filed: Dec. 2, 2014
(86) PCT No.: PCT/EP2014/076221

§ 371 Date: Jun. 6, 2016

(30) Foreign Application Priority Data
Dec. 4, 2013 (DE) 10 2013 224 898.9

(51) Int. Cl. F16K 31/06

(52) U.S. Cl. CPC F16K 31/0627; F16K 31/0693

(57) ABSTRACT

The invention relates to a solenoid valve (10), in particular for a liquid-regulated heating and/or cooling system, comprising a valve housing (16), which has at least three channels (12, 14, 15), in particular feed or outlet channels, and an electromagnetically-switched first valve element (18) which is secured on a valve shaft (26) together with an armature (32) and which establishes the connection between the first channel (12) and the third channel (15) in a first switch position and blocks said connection in a second switch position. The valve shaft (26) is plunged into an armature area (54) together with the armature (32), a liquid at least temporarily flowing through said armature area via movement gaps (80) and via an axial channel (48) in the valve shaft (26). The armature area (54) is connected to the third channel (15) on the first valve element (18) face facing the armature area (54) via the movement gaps (80) and via the axial channel (48), said third channel (15) being designed as an auxiliary feed channel (15).

### BACKGROUND OF THE INVENTION

The invention relates to a solenoid valve having optimal ventilation.

The German patent specification DE 195 37 067 C1 discloses that, in the case of a solenoid valve which is disposed in a feed line of a heat exchanger, fluid passes through the armature area of the solenoid valve by utilizing the pressure gradient between the feed line and the return line in order to remove air bubbles from the armature area and to avoid the disadvantages associated therewith. To this end, a ventilation line is provided between the armature area and the return line, wherein fluid from a feed line flows into the ventilation line via an annular gap between the armature and the coil of the solenoid valve and prevents air bubbles from collecting in the armature area.

It is further known from the German patent specification DE 34 16 465 A1 in the case of a solenoid valve to connect an armature area via an axial channel in an armature shaft to a line section which lies on the side of the valve element facing the armature area. During the valve actuation, air is forced out of the armature area and liquid is suctioned in by means of the pumping action of the armature. Due to the compressibility of the air, a sufficient liquid exchange does, however, not always take place between the armature area and the line section and under certain circumstances the air can remain enclosed in the upper, annular portion of the armature area.

A solenoid valve is known from the German patent specification DE 198 09 047 A1, wherein an opening of the axial shaft protrudes into a channel through which much liquid passes.

### SUMMARY OF THE INVENTION

The solenoid valve according to the invention has the advantage with respect to the solenoid valves known from the prior art that the flow of liquid through the armature area of the solenoid valve is lower, whereby the probability of contamination due to particles in the liquid is reduced. In addition, the movements of the armature are hydraulically dampened in order to prevent an abrupt closing thereof and associated pressure surges. Noise as well as wear which arise if the valve element strikes the valve seat in an undamped manner are also prevented.

The solenoid valve can be simply integrated into new or existing systems. To this end, the individual channels have to each be connected to a line section, in particular of the heating and/or cooling system. By means of the connection to the heating or cooling system, the liquids, which have different temperatures, can be mixed in the valve. As a result of this mixing, a temperature increase or temperature decrease of the liquid dispensed at the valve takes place as a function of the mixing ratio. Hence, the solenoid valve can be used in many areas of application, for example in a cooling system in a vehicle or in a heating or cooling system in buildings. The solenoid valve could also be used in mixing plants.

The third channel is advantageously designed as an auxiliary feed channel. An auxiliary feed channel can, for example, have a smaller flow rate due to a smaller cross section. In addition, liquid does not continuously flow through the auxiliary feed channel in contrast to the other channels. The auxiliary feed channel can advantageously contain another liquid or a liquid having a different temperature with respect to the first and the second channel. The solenoid valve particularly facilitates a mixing of the liquids from the auxiliary feed channel and a further channel and vice versa. A metering of the liquid added from auxiliary feed channel can, for example, be carried out by means of a clocked change of the switch positions. The pulsing takes place via PWM actuation of the solenoid valve.

Channels through which liquid flows into the valve are denoted as feed channels. Channels via which liquids flow out of the valve are denoted as outlet channels. The auxiliary third channel is advantageously designed as a feed channel. If said auxiliary third channel is designed as a feed channel, the armature area is supplied with liquid to a great extent from the auxiliary third channel.

It is particularly advantageous for the valve shaft to be elongated on the side of the valve element facing away from the armature area and to carry a second valve element. The second valve element establishes the connection between the first channel and the second channel in a second switch position. In a first switch position, the second valve element interrupts the connection between the first and the second channel. The connection between the first and the second channel can be established or blocked by means of the second valve element. A connection between the first channel and the auxiliary third channel or between the first channel and the second channel is possible depending on the switch position. It is conceivable to introduce warm or cold liquids into a line section.

It is furthermore advantageous if the valve shaft has an opening which establishes a connection between the auxiliary third channel and the axial channel. The opening can, for example, be designed as a borehole. An opening enables a defined feed of liquid or outflow of liquid, respectively a defined transport of liquid, via the axial channel in the valve shaft into the armature area. The valve shaft can also advantageously have a notch, a slot, a cross hole or another type of opening which establishes a connection between the auxiliary third channel and the axial channel. Depending on the type of opening, the strength of the feed or outflow can be defined. Turbulences, which result in a cleaning effect on the axial channel, can also be generated by the type of the opening.

In an advantageous manner, a throttling effect can be achieved by means of the type of the opening or, respectively, the borehole between the auxiliary third channel and the axial channel. To this end, either the axial channel or the opening can have a throttle point or be designed as a throttle point. By altering the type of opening, a throttle point can, for example, be formed with little cost or effort during production. The throttle point in the axial channel can be designed as a restriction, insert, adhesive dot, weld spot or solder spot. A variation of the inside diameter of the axial channel can also have a throttling effect. A borehole, a cross hole, a narrow gap or a notch can serve as an opening. Notching the valve shaft with a saw is, however, also an option.

In order that the liquid does not spread in an uncontrolled manner in the solenoid valve, it is advantageous if a diaphragm seal rests with a sealing lip thereof on the valve shaft on the side of the valve element facing the armature area. The diaphragm seal delimits the flow through the armature area and prevents the armature area from running dry at rest. The armature area would fill with air as a result of said armature area emptying. This would suppress the hydraulically damping effect of the liquid in the armature area. The lubrication and cooling of the solenoid valve would also be negatively impacted.

It is further advantageous for the first channel to be an outlet channel. In so doing, a selection can be made between two feed channels, wherein the second channel and the auxiliary channel are each a feed channel. It is also conceivable for the first channel to be a feed channel and the second channel and the auxiliary third channel to form an outlet channel. In this case, the solenoid valve could be adjusted as to whether the outflow is to take place via the second or the auxiliary third channel.

The valve advantageously comprises two switch positions, wherein the auxiliary third channel is connected to the first channel in a second switch position and the first channel is connected to the second channel in a second switch position. A use of two switch positions simplifies the design and the actuation of the valve. No intermediate positions are required which require a complicated query of the current position. The solenoid valve can, for example, assume the second switch position by means of the force of a spring and assume the first switch position by means of the force of a magnetic field and vice versa.

A multiple infeed or, respectively, plunge-cut grinding of the valve shaft entails increased effort during production and is therefore cost intensive. Dirt particles can also lodge in the indentations or stepped portions. For this reason, it is a particularly advantageous design if the valve shaft is processed by means of through-feed grinding.

The first valve element preferably comprises a first valve cone and a first valve seat; and the second valve element a second valve cone and a second valve seat.

It is furthermore advantageous if the cost and effort for the production of the solenoid valve is reduced by the first valve cone of the first valve element and the second valve cone of the second valve element being designed as one piece. The valve cone designed as one piece can be easily installed. In addition, no tolerances between the first and the second valve cone have to be compensated. The installation of the solenoid valve is simplified by the valve cone designed as one piece.

It has, furthermore, been shown that a variation of the cross section between the individual channels is advantageous. Hence, particularly the cross section of the auxiliary third channel is smaller than that of the first channel or the second channel.

### BRIEF DESCRIPTION OF THE DRAWINGS

Further features of the invention ensue from the drawings and are explained in greater detail in the following description. In the drawings:

FIG. 1 shows a solenoid valve according to the prior art;

FIG. 2 shows a solenoid valve according to the invention; and

FIG. 3 shows a further exemplary embodiment of a solenoid valve comprising an integrally formed valve cone.

### DETAILED DESCRIPTION

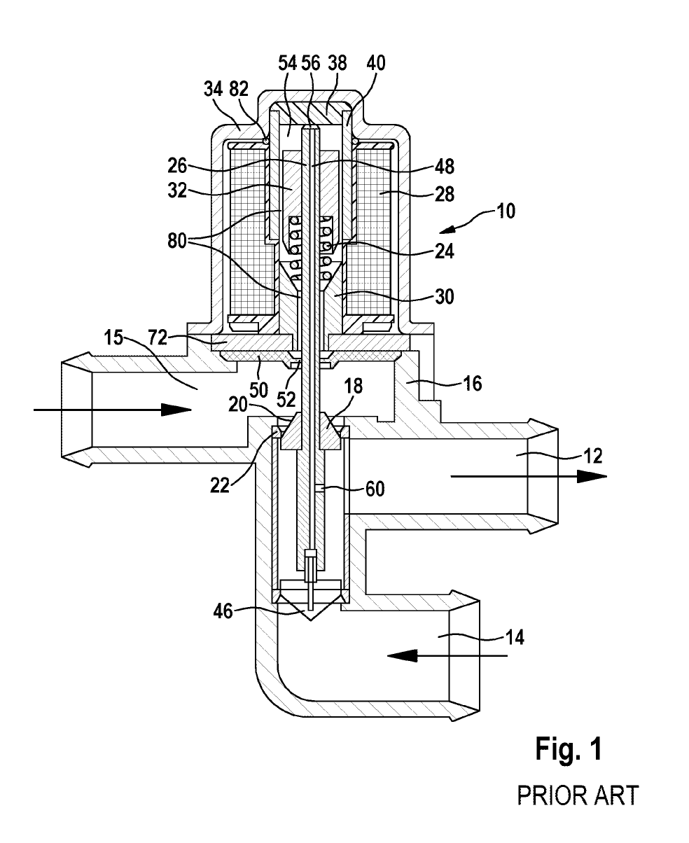

The solenoid valve 10 according to FIG. 1 is, for example, disposed between an internal combustion engine and a heat exchanger in a feed line. Said solenoid valve has a feed channel 14, which is connected to the internal combustion engine and an outlet channel 12, which is particularly connected to the heat exchanger and an auxiliary third channel 15 which is used as a connection channel. A first valve element 18 is provided between the outlet channel 12 and the auxiliary third channel 15, said first valve element interacting with a first valve seat 22 in a valve housing 16 via a first valve cone 20 and, in a first switch position, establishes the connection between the auxiliary third channel 15 and the outlet channel 12 and blocks said connection in a second switch position, the closing position. The valve element 18 comprises a valve seat 22 in a valve housing 16 and a valve cone 20. A second valve element 46 is provided between the channels 12 and 14, said second valve element interacting via a second valve cone 21 with a second valve seat 23 in the valve housing 16. In a first switch position, the valve element 46 blocks the connection between the feed channel 14 and the outlet channel 12. In a second switch position, the second valve element establishes the connection.

The solenoid valve 10 further comprises a valve shaft 26. The first valve element 18, the second valve element 46 and the armature 32 are connected particularly in a positive locking and friction locking manner by means of the valve shaft 26. The armature 32 interacts with a magnetic coil 28. The armature 32 is guided through a guide bushing 40 in an axially displaceable manner in an armature area 54.

A valve spring 24 holds the valve element 18 in a closed position as long as a current is not passed through the magnetic coil 28, in particular is not magnetically excited. If current is passed through the magnetic coil 28, a magnet core 30, which with the plate 72, the magnet pot 34 and the guide bushing 40 forms the magnetic circuit, pulls the armature 32 against the force of the valve spring 24. The valve element 18 opens the connection between the auxiliary third channel 15 and the outlet channel 12. Movement gaps 80 are provided between the armature 32 and the guide bushing 40 as well as between the valve shaft 26 and the magnet core 30 for the movement of the armature 32 and the valve shaft 26, said movement gaps forming at least temporarily a connection between the armature area 54 and the auxiliary third channel 15. The armature area 54 is furthermore connected to the channel 12 via an axial channel 48.

Due to the pressure gradient between the auxiliary third channel 15 and the outlet channel 12, in particular in the closed position of the valve element 18, liquid flows via the axial channel 48 and the movement gap 80 through the armature area. The flowing liquid removes air or, respectively, gas accumulations in the armature area 54. The axial channel 48 is connected via a cross hole 60 to the feed channel 12. Due to the pressure gradient between the cross hole 60 and the auxiliary third channel 15, liquid flows through the armature area 54 in the direction of the auxiliary third channel 15.

The flow rate of liquids through the armature area can be determined by a defined throttle point in the axial channel 48 or in a cross hole 60. The defined throttle point prevents deposits of dirt and/or limits the amount of leakage when the valve element 18 is closed. The axial channel 48 or the cross hole 60 can, however, also themselves be dimensioned for delimiting the flow rate in such a way that they act as throttle points.

Despite a defined throttle point in the axial channel 48 or in the cross hole 60, liquid constantly flowing through the armature area 54 can lead to deposits of dirt in the armature area 54. The feed channel 14 and the outlet channel 12 form both main channels, through which more liquid passes in comparison to the auxiliary third channel 15. Liquid flows through the armature area 54 by means of the connection of the armature area 54 to one of the two main channels 12, 14. As a result, an increased risk of contamination of the armature area 54 exists.

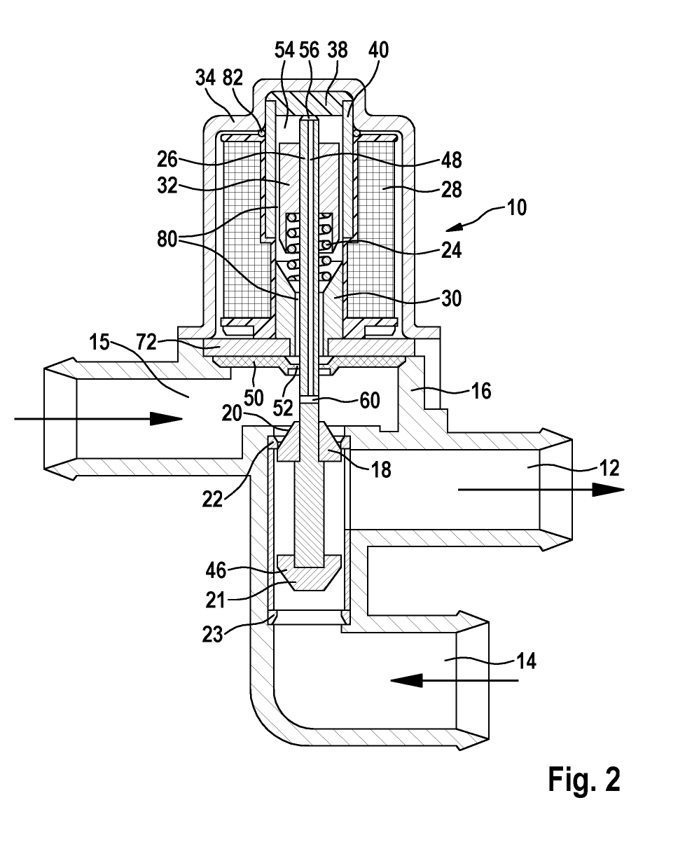

FIG. 2 shows an exemplary embodiment for a solenoid valve 10 according to the invention. In the solenoid valve 10, the armature area 54 is connected via two connections to the auxiliary third channel 15. The first connection is established via the axial channel 48 and an opening 60. The second connection is established by means of the movement gap 80. The opening 60 can thereby be designed as a gap, cross hole, notch or borehole.

If the connection between the auxiliary third channel 15 and the first channel 12 is established, a small portion of the liquid then flows through the opening 60 and the axial channel 48 into the armature area 54. Starting at the armature area 54, the liquid flows through the movement gap back into the auxiliary third channel 15. The opening 60, the axial gap 48, the armature area 54, the movement gap 80 and the auxiliary third channel 15 form a circuit. The liquid circuit has the advantage that air bubbles are pressed out of the armature area, in particular flushed out of said armature area. Depending on the type and form of the opening 60 and the axial channel 48, throttling effects can be achieved.

A pumping action is furthermore produced by the movement of the armature 32 and thus the displacement of the liquid in the armature area 54. Air bubbles are pressed out of the armature area 54 by means of the pumping action.

By means of the connection of the armature area 54 to the auxiliary third channel 15 via the axial channel 48 and the movement gap 80, liquid flows through the armature area 54 only in the first switch position or, respectively, when connecting the auxiliary third channel 15 to the first channel 12. Hence, liquid does not constantly flow through the armature area 54. This results in a reduction of the probability of contamination. The required purity of the liquid is lower in the case of the solenoid valve according to the invention than in the case of solenoid valves 10 that are known in the prior art.

The adjoining components such as the magnet core, armature 32, guide bushing 40 and valve shaft 26 are cooled and lubricated by the liquid in the movement gap 80.

The solenoid valve 28 is situated in a magnet pot 34 which is secured to a valve housing 16

In addition, the armature area 54 is prevented from running dry via the movement gaps 80 by means of a diaphragm seal 50 comprising a sealing lip 52. The diaphragm seal 50 and the sealing lip 52 must, however, allow a liquid flow if the auxiliary third channel 15 is connected to the first channel 12. The diaphragm seal 50 and the sealing lip 52 have a sealing effect that is dependent on pressure.

The type of channel i.e. whether it relates to a feed channel or an outlet channel depending on the field of application for the first channel 12, the second channel 14 and the auxiliary third channel 15, is selected by means of the design of the solenoid valve 10 and the arrangement of the opening 60 in the auxiliary channel 15. The solenoid valve 10 can therefore be used more flexibly in relation to solenoid valves known from the prior art. By way of example, the auxiliary third channel 15 and the second channel are designed as a feed channel in FIG. 2. The first channel 12 is designed as an outlet channel. It is however also possible to design the first channel 12 as a feed channel and the second channel 14 and the auxiliary third channel 15 as an outlet channel.

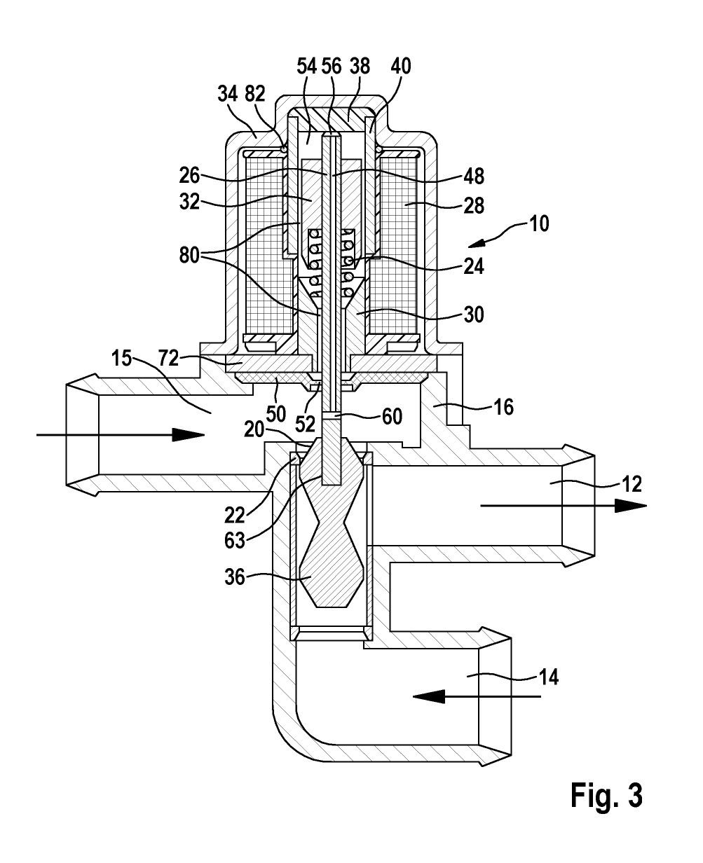

FIG. 3 shows a further exemplary embodiment comprising a valve cone 36 designed as a single part. In the exemplary embodiment, the first valve cone 20 of the first valve element 18 is integrally formed with the second valve cone 21 of the second valve element 46. The one-piece valve cone 36 comprises a valve shaft receptacle 63 into which the valve shaft 26 can be inserted. The valve shaft 26 is of one-piece design, in particular through-feed ground, and thus can be easily manufactured. The one-piece valve cone 36 is connected to the valve shaft 26 by means of welding, press-fitting, soldering or adhesive bonding. The valve shaft 26 can however also be connected to the one-piece valve cone 36 so as to be rotationally fixed as well as fixed in position by means of a positive locking or friction locking connection in the valve shaft receptacle 26.

The invention can thus be used for a multiplicity of valve variants and valve arrangements without costly adaptations being required.

According to a further embodiment of the invention, the solenoid valve 10 comprises a stop 38. The stop 38, at which the valve shaft 26 rests in the first switch position of the solenoid valve 10, closes the guide bushing 40 or, respectively, the armature area 54 at the end face. A cross hole 56 at the armature-area end of the valve shaft 26 also then secures the connection if the valve shaft 26 abuts against the stop 38 in the open position. The stop 38 is expediently produced from a dampening plastic material.

1. A solenoid valve (10), comprising a valve housing (16), which has at least first, second and third channels (12, 14, 15), and an electromagnetically-switched first valve element (18) which is secured on a valve shaft (26) together with an armature (32) and which establishes a connection between the first channel (12) and the third channel (15) in a first switch position and blocks said connection in a second switch position, wherein the valve shaft (26) extends into an armature area (54) together with the armature (32), a liquid at least temporarily flowing through said armature area via movement gaps (80) and via an axial channel (48) in the valve shaft (26), characterized in that the armature area (54) is connected to the third channel (15), adjacent a face of the first valve element (18) facing the armature area (54), via the movement gaps (80) and via the axial channel (48), said third channel (15) being an auxiliary feed channel (15).

2. The solenoid valve (10) according to claim 1, characterized in that each of the first, second and third channels (12, 14, 15) is connected to a line section.

3. The solenoid valve (10) according to claim 1, characterized in that a liquid does not continuously flow through the third channel (15).

4. The solenoid valve (10) according to claim 1, characterized in that the valve shaft (26) is elongated on a side of the valve element (18) facing away from the armature area (54) and carries a second valve element (46) which establishes a connection between the first channel (12) and the second channel (14) in the second switch position and blocks said connection between the first channel (12) and the second channel (14) in the first switch position.

5. The solenoid valve (10) according to claim 1, characterized in that the valve shaft has an opening (60), which establishes a connection between the third channel (15) and the axial channel (48).

6. The solenoid valve (10) according to claim 1, characterized in that the axial channel (48) or the opening (60) has a throttle point or is designed as a throttle point.

7. The solenoid valve (10) according to claim 1, characterized in that a diaphragm seal (50) comprising a sealing lip (52) rests on the valve shaft (26) on a side of the third channel (15) facing the armature area (54), said diaphragm seal delimiting flow of liquid through the armature area (54) and preventing the armature area (54) from running dry at rest.

8. The solenoid valve (10) according to claim 1, characterized in that the first channel (12) is an outlet channel and the second channel (14) is a feed channel.

9. The solenoid valve (10) according to claim 3, characterized in that the third channel (15) is connected to the first channel (12) in a first switch position, and the first channel (12) is connected to the second channel (14) in a second switch position.

10. The solenoid valve (10) according to claim 1, characterized in that the valve shaft (26) is through-feed ground.

11. The solenoid valve (10) according to claim 1, characterized in that the first valve element (18) comprises a first valve cone (20) and a first valve seat (22), and the second valve element (46) comprises a second valve cone (21) and a second valve seat (23).

12. The solenoid valve (10) according to claim 11, characterized in that the first valve cone (20) and the second valve cone (21) are designed as one-piece.

13. The solenoid valve (10) according to claim 1, characterized in that a cross hole of the third channel (15) is smaller than that of the first channel (12) or that of the second channel (14).

14. The solenoid valve (10) according to claim 1, wherein the solenoid valve is configured for a liquid-regulated heating and/or cooling system.

15. The solenoid valve (10) according to claim 14, characterized in that each of the first, second and third channels (12, 14, 15) is connected to a line section of the heating and/or cooling system.

16. The solenoid valve (10) according to claim 1, characterized in that the valve shaft has a borehole, which establishes a connection between the third channel (15) and the axial channel (48).

17. The solenoid valve (10) according to claim 1, wherein the opening (60) is a cross hole, and wherein the axial channel (48) or the cross hole has a throttle point or is designed as a throttle point.
